(19) United States
(12) Patent Application Publication
(10) Pub. No.: US 2014/0308042 A1
(43) Pub. Date: Oct. 16, 2014

(54) UNDERWATER COMMUNICATION DEVICE USING VISIBLE LIGHT AND UNDERWATER COMMUNICATION METHOD USING THE SAME

(71) Applicants: Hee Sung Woo, Daejeon (KR); Chang Hyoung Ryu, Daejeon (KR); In Ho Song, Daejeon (KR); Hyun Cheol Jeong, Daejeon (KR); Sung Won Cho, Daejeon (KR); Sung Jun Lee, Daejeon (KR)

(72) Inventors: Hee Sung Woo, Daejeon (KR); Chang Hyoung Ryu, Daejeon (KR); In Ho Song, Daejeon (KR); Hyun Cheol Jeong, Daejeon (KR); Sung Won Cho, Daejeon (KR); Sung Jun Lee, Daejeon (KR)

(21) Appl. No.: 13/703,130

(22) PCT Filed: Sep. 25, 2012
(86) PCT No.: PCT/KR12/07693

§ 371 Date: Dec. 10, 2012

(30) Foreign Application Priority Data
Oct. 4, 2011 (KR) 10-2011-0100780

(51) Int. Cl. H04B 10/11; H04B 10/2575; H04B 10/80

(52) U.S. Cl. CPC H04B 10/11; H04B 10/80; H04B 10/2575
USPC 398/104

(57) ABSTRACT

Provided are an underwater communication device using visible light and an underwater communication method using the same. The underwater communication device using visible light, includes: an input unit converting a data signal received from the outside under water into an electrical signal; a transmitting unit converting the electrical signal into a visible light signal and emitting the visible light signal under water; a receiving unit recognizing the visible light signal under water and converting the visible light signal into the electrical signal; and an output unit converting the electrical signal into a data signal and outputting the data signal under water. Therefore, it is possible to provide an underwater communication device that may be implemented at low cost, perform wide band communication, and have excellent security.

### Technical Field

The present invention relates to an underwater communication device using visible light and an underwater communication method using the same, and more particularly, to an underwater communication device capable of improving a data transmission speed and security, and an underwater communication method using the same.

### Background Art

A visible communication technology has been on the rise due to more frequency shortages according to introduction of a new service as well as an existing service in wireless communication technologies on which a ubiquitous technology is based, an increase in demand for a high definition precise content according to performance improvement of a portable digital device such as a smart phone, a tablet personal computer (PC), or the like, and the necessity for supplementation of a wireless frequency communication technology according to regulation of a limited frequency resource and the next generation wireless communication technology capable of transmitting high speed and large capacity data.

In the visible communication technology, which is a free space optic (FSO) technology corresponding to an optical communication technology using light propagating in a free space for transceiving data between two devices installed on the line of sight (LOS), data are transmitted by flickering a light emitting diode (LED) at an invisible speed and data communication is performed using a wavelength of 380 to 780 nm

Generally, as underwater wireless communication, there is a fish detector detecting underwater fishes, a depth sounder investigating the seabed and a shape of rocks, a sonar detecting a screw sound of a military ship such as a submarine, or an active sonar sending a microwave pulse such as an air microwave radar and investigating existence of ships or rocks by a reflected wave. Recently, a method of performing underwater wireless communication using an ultrasonic wave has also been developed.

Meanwhile, since an electric wave has a property in which it is scattered and absorbed under water, it is difficult to perform underwater wireless communication using the electric wave. Therefore, it is general to perform communication using an ultrasonic wave under water.

In addition, the ultrasonic wave has characteristics that a transfer speed is slow, such that a time delay is large, and a bandwidth is narrow, such that a data transmission rate is low.

FIG. 1 is a perspective view of a communication device for underwater wireless communication according to the related art.

As shown in FIG. 1, a communication device for performing underwater wireless communication disclosed in Korean Patent Laid-Open Publication No. 2010-0031445 is configured to include a modulator 22 receiving an ultrasonic signal to generate a transmission symbol including a modulation section in which the ultrasonic signal is modulated into a modulation signal and a protection section inserted into a front end or a rear end of the modulation section, an amplifier 21 amplifying the ultrasonic signal, an ultrasonic sensor 10 transceiving the ultrasonic signal using an underwater channel, a channel coder 24 coding the underwater channel, and a demodulator 23 demodulating the modulation signal into an original signal.

In the related art, a method and device capable of improving transmission efficiency of information by minimizing signal interference according to a multipath that may be generated under water, more specifically, an underwater communication device and method capable of reducing an error of transmission and reception, efficiently transmitting information, improving reliability of the transmission and reception by considering an underwater environment that may improve transmission efficiency in underwater wireless communication are provided.

However, in the related art, when the underwater communication is performed, since only interference according to a transmission path of the ultrasonic wave is minimized, a bandwidth of communication is short, such that a transmission speed of data is slow.

In addition, in the related art, expensive apparatuses such as the ultrasonic sensor and the channel coder are used, such that it takes a large cost to implement the apparatuses.

Further, in the related art, an ultrasonic communication scheme in which security is not made is used, such that tapping may be made.

### Related Art Document

### Patent Document

(Patent Document 1) Korean Patent Laid-Open Publication No. 2010-0031445 (Mar. 22, 2010)

### Disclosure Of Invention

### Technical Problem

An object of the present invention is to provide an underwater communication device using visible light capable of increasing a data transmission speed and being implemented at a low cost by being configured to perform communication under water through a light emitting diode (LED) visible light, and an underwater communication method using the same.

### Solution to Problem

In one general aspect, an underwater communication device using visible light, includes: an input unit 100 receiving a data signal under water and converting the data signal into an electrical signal; a transmitting unit 200 including a signal magnitude adjusting unit 210 adjusting intensity of the electrical signal, a light emitting diode (LED) driving unit 220 driving an LED illumination or generating an illumination signal, a signal summing unit 230 summing up the electrical signal and the illumination signal to generate a complex light signal, and a visible light emitting unit 240 adjusting a wavelength of the complex light signal to emit a visible light signal to underwater, the LED driving unit 220 being operated in any one of an automatic mode of always driving the LED illumination and generating the illumination signal when it is confirmed that the signal magnitude adjusting unit 210 is driven, an illumination mode of always driving the LED illumination, a communication mode of always generating the illumination signal, and a turn off mode of not driving the LED illumination and not generating the illumination signal; a receiving unit 300 recognizing the visible light signal under water and converting the visible light signal into the electrical signal; and an output unit 400 converting the electrical signal into a data signal and outputting the data signal under water.

The data signal may be an audio signal or an analog signal.

The input unit 100 may be a microphone or a touch pad.

The output unit 400 may be a headset or a monitor.

The LED driving unit 200 may further include a mode selecting switch 225 capable of selecting any one of the automatic mode, the illumination mode, the communication mode, and the turn off mode.

The receiving unit 300 may include: a visible light photosensitive unit 310 recognizing the visible light signal; an amplifier 320 amplifying the visible light signal; a demodulating unit 330 converting the visible light signal into the electrical signal; and a filter unit 340 filtering the electrical signal.

The visible light photosensitive unit 310 may be a photodiode.

In another general aspect, a method of transmitting a data signal under water in the underwater communication device 1000 using visible light as described above, includes: a step (S01) of setting the LED driving unit 220 to the automatic mode or the communication mode under water; a step (S02) of inputting the data signal to the input unit 100 under water and converting the data signal into the electrical signal; a step (S03) of adjusting, in the signal magnitude adjusting unit 210, a magnitude of the electrical signal; a step (S04) of generating, in the LED driving unit 220, an illumination signal; a step (S05) of summing up, in the signal summing unit 230, the electrical signal of which the magnitude is adjusted and the illumination signal to generate a complex light signal; and a step (S06) of converting, in the visible light emitting unit 240, the complex light signal into the visible light signal and emitting the visible light signal to underwater.

In still another general aspect, a method of receiving a data signal under water in the underwater communication device 1000 using visible light as described above, includes: a step (S07) of recognizing, in the visible light photosensitive unit 310, the visible light signal emitted from the visible light emitting unit 240 under water; a step (S08) of amplifying, in the amplifier 320, the visible light signal; a step (S09) of converting, in the demodulating unit 330, the amplified visible light signal into the electrical signal; a step (S10) of filtering, in the filter unit 340, the electrical signal; and a step (S11) of converting, in the output unit 400, the filtered electrical signal into the data signal and outputting the data signal.

### Advantageous Effects of Invention

Therefore, according to the exemplary embodiment of the present invention, the communication is performed under water using the LED visible light, such that a data transmission speed is rapid.

In addition, according to the exemplary embodiment of the present invention, the communication is performed under water using the LED, which is an environment-friendly illumination, thereby making it possible to implement an environment-friendly and cheap underwater communication device.

Further, according to the exemplary embodiment of the present invention, the communication is performed under water while controlling the LED in several modes and the illumination signal is generated, thereby making it possible to efficiently confirm a state required for communication.

Furthermore, according to the exemplary embodiment of the present invention, the communication is performed under water using the LED visible light, thereby making it possible to perform wideband communication and improve security.

### BRIEF DESCRIPTION OF DRAWINGS

The above and other objects, features and advantages of the present invention will become apparent from the following description of preferred embodiments given in conjunction with the accompanying drawings, in which:

FIG. 1 is a perspective view of a communication device for underwater wireless communication according to the related art.

FIG. 2 is a view showing an underwater communication device using visible light according to an exemplary embodiment of the present invention.

FIG. 3 is a block configuration diagram showing the underwater communication device using visible light according to the exemplary embodiment of the present invention.

FIG. 4 is a flow chart showing a transmission method of the underwater communication device using visible light according to the exemplary embodiment of the present invention.

FIG. 5 is a flow chart showing a reception method of the underwater communication device using visible light according to the exemplary embodiment of the present invention.

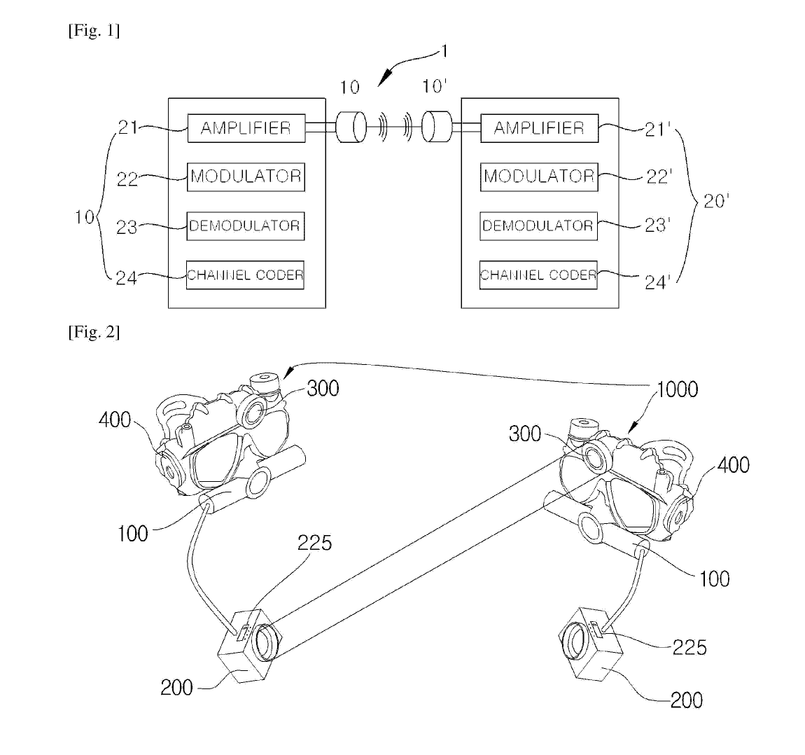

### DETAILED DESCRIPTION OF MAIN ELEMENTS

1: Underwater communication device according to the related art
10: Ultrasonic sensor 20: Communication device
30: Channel Coder
1000: Underwater communication device using visible light according to n exemplary embodiment of the present invention
100: Input unit 200: Transmitting unit
210: Signal magnitude adjusting unit 220: LED driving unit
230: Signal summing unit
240: Visible light emitting unit
300: Receiving unit
310: Visible light photosensitive unit
320: Amplifier 330: Demodulating unit
340: Filter unit 400: Output unit

### BEST MODE FOR CARRYING OUT THE INVENTION

Hereinafter, a technical spirit of the present invention will be described in more detail with reference to the accompanying drawings.

FIG. 2 is a view showing an underwater communication device using visible light according to an exemplary embodiment of the present invention; and FIG. 3 is a block configuration diagram showing the underwater communication device using visible light according to the exemplary embodiment of the present invention.

As shown in FIG. 2, the underwater communication device 1000 using visible light according to the exemplary embodiment of the present invention is configured to include an input unit 100, a transmitting unit 200, a receiving unit 300, and an output unit 400. As an example, the underwater communication device 1000 using visible light according to the exemplary embodiment of the present invention is configured to include the input unit 100 provided in an oxygen mask of a skin scuba apparatus, the transmitting unit 200 connected to the oxygen mask, the receiving unit 300 connected to a cross section of swimming goggles of the skin scuba apparatus, and the output unit 400 connected to both ends of the skin scuba apparatus, wherein each of the units may be connected to each other, but may also be connected to various positions.

The underwater communication device 1000 using visible light according to the exemplary embodiment of the present invention is configured so that each of the input unit 100, the transmitting unit 200, the receiving unit 300, and the output unit 400 is waterproofed in order to be used under water.

As shown in FIG. 3, the input unit 100 receives a data signal transferred under water and converts the data signal into an electrical signal.

Here, the data signal is an audio signal or an analog signal transferred under water. However, the data signal is not limited thereto, but may be various signals.

In addition, the input unit 100 may be a microphone receiving an audio signal transferred from the outside and converting the audio signal into an electrical signal or a touch pad receiving an analog signal transferred from the outside and converting the analog signal into an electrical signal. However, the input unit 100 is not limited thereto, but may be a device capable of inputting various signals.

The transmitting unit 200 is configured to include a signal magnitude adjusting unit 210, a light emitting diode (LED) driving unit 220, a signal summing unit 230, and a visible light emitting unit 240, each of which will be described in detail.

The signal magnitude adjusting unit 210 receives the electrical signal from the input unit 100 under water and adjusts intensity of the electrical signal.

In addition, the LED driving unit 220 drives an LED illumination under water or generates an illumination signal.

Here, the meaning that the LED driving unit 220 drives the LED illumination is that the LED driving unit 220 drives an LED illumination with a white color as a role of an illumination, and the meaning that the LED driving unit 220 generates the illumination signal is that the LED driving unit 220 generates an illumination signal having a red color as a role for communication under water. The LED illuminating unit 220 is not limited thereto, but may drive the LED illumination with various colors in addition to the white color and generate illumination signals having various colors in addition to the red color.

In addition, the LED driving unit 220 is controlled in any one of an automatic mode of driving the LED illumination and stopping the driving of the LED illumination and automatically generating the illumination signal when it is confirmed that the signal magnitude adjusting unit 210 is driven, an illumination mode of always driving the LED illumination, a communication mode of always generating the illumination signal, and a turn off mode of turning off power.

Further, the LED driving unit 220 may further include a mode selecting switch 225 capable of selecting any one of the automatic mode, the illumination mode, the communication mode, and the turn off mode.

Further, the signal summing unit 230 receives the electrical signal of which a magnitude is adjusted from the signal magnitude adjusting unit 210 and the illumination signal from the LED driving unit 220 under water and sums up these two signals to generate a complex light signal.

In addition, the visible light emitting unit 240 adjusts a wavelength of the complex light signal to emit a visible light signal to underwater. Here, the meaning of adjusting the wavelength of the complex light signal is to adjust the wavelength of the complex light signal to a 380 to 780 nm which is a bandwidth of a wavelength of a visible light signal.

The receiving signal 300 is configured to include a visible light photosensitive unit 310, an amplifier 320, a demodulating unit 330, and a filter unit 340, each of which will be described in more detail.

The visible light photosensitive unit 310 recognizes the visible light signal emitted from the visible light emitting unit 240 to the underwater under water. Here, the visible light photosensitive unit 310 is a photodiode.

In addition, the amplifier 320 receives and amplifies the visible light signal recognized from the visible light photosensitive unit 310 under water.

Further, the demodulating unit 330 receives the amplified visible light signal from the amplifier 320 and converts the amplified visible light signal into an electrical signal so that the visible light signal may be easily output.

Further, the filter unit 340 receives the converted electrical signal from the demodulating unit 300 under water and removes an erroneous bandwidth of the electrical signal erroneously received in an underwater transmission process.

Visible light is subjected to relatively less interference as compared with an ultrasonic wave in a transmission and reception process under water.

Therefore, the underwater communication device 1000 using visible light according to the exemplary embodiment of the present invention performs communication under water using the LED visible light, such that communication may be performed in a wide band and security is excellent.

In addition, according to the exemplary embodiment of the present invention, the communication is performed under water using the LED visible light, such that a data transmission speed is rapid.

The output unit 400 receives the electrical signal from the receiving unit under water and outputs an audio signal or an analog signal.

In addition, the output unit 400 may be a microphone converting the electrical signal into the audio signal and outputting the audio signal or a monitor converting the electrical signal into the analog signal and outputting the analog signal. However, the output unit 400 is not limited thereto, but may also be a device capable of outputting various signals.

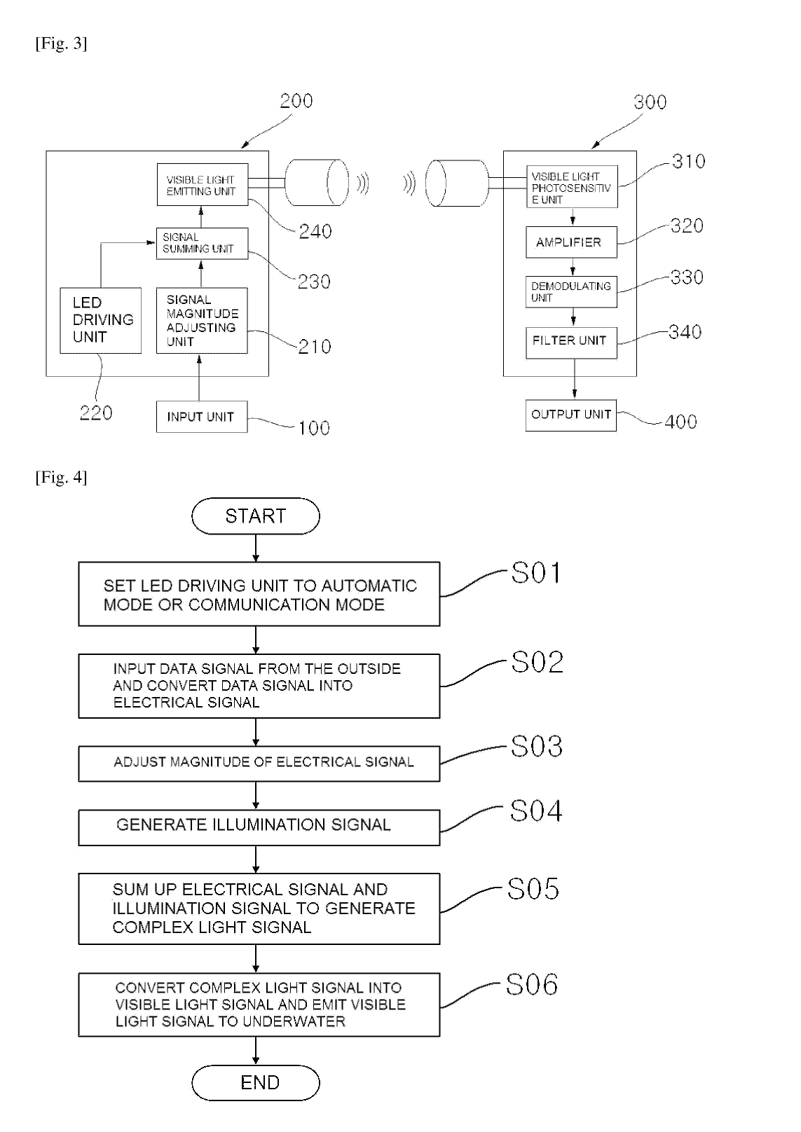

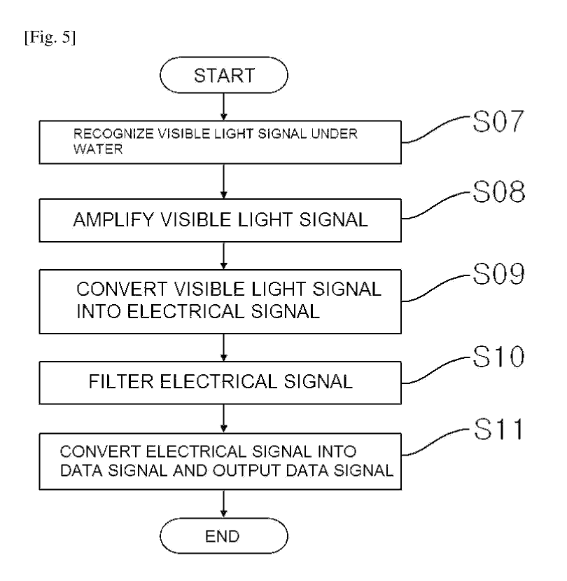

FIG. 4 is a flow chart showing a transmission method of the underwater communication device using visible light according to the exemplary embodiment of the present invention; and FIG. 5 is a flow chart showing a reception method of the underwater communication device using visible light according to the exemplary embodiment of the present invention. Hereinafter, a method of transmitting a data signal in the underwater communication device using visible light according to the exemplary embodiment of the present invention and a method of receiving a data signal in the underwater communication device using visible light according to the exemplary embodiment of the present invention will be described in more detail.

As shown in FIG. 4, the method of transmitting a data signal under water in the underwater communication device 1000 using visible light is configured to include the following steps.

First, the LED driving unit 220 is set to the automatic mode or the communication mode using the mode selecting switch 225. When the LED driving unit 220 is set to the illumination mode or the turn off mode, since a data signal may not be transmitted, the LED driving unit 220 is set to the automatic mode or the communication mode. When the LED driving unit 220 is driven in the automatic mode, the LED illumination is driven, and when the LED driving unit 220 is driven in the communication mode, the illumination signal is generated. This corresponds to operation step (S01) shown in FIG. 4.

In addition, the audio or analog signal input from the outside under water is input to the input unit 100. Further, the audio or analog signal is converted into the electrical signal so as to be transmitted to the signal magnitude adjusting unit 210. This corresponds to operation step (S02) shown in FIG. 4.

Next, the signal magnitude adjusting unit 210 receives the electrical signal converted in the input unit 100. In addition, the signal magnitude adjusting unit 210 adjusts a magnitude of the electrical signal. This corresponds to operation step (S03) shown in FIG. 4.

Next, the LED driving unit 220 generates the illumination signal. In this case, the LED driving unit 200 automatically stops the driving of the LED and generates the illumination signal when it is configured that the signal magnitude adjusting unit 210 is driven in the automatic mode and always generates the illumination signal in the communication mode, according to the mode set in step S01. This corresponds to operation step (S04) shown in FIG. 4.

Then, the signal summing unit 230 sums up the electrical signal of which the magnitude is adjusted in the signal magnitude adjusting unit 210 and the illumination signal generated in the LED driving unit. In addition, the signal summing unit 230 sums up these two signals to generate the complex light signal. This corresponds to operation step (S05) shown in FIG. 4.

Next, the visible light emitting unit 240 converts the complex light signal generated in the signal summing unit into the visible light signal having a bandwidth of 380 to 780 nm In addition, the visible light emitting unit 240 emits the visible light signal to the underwater. In this case, a basic emitting width of the visible light signal is R (660 nm), G (530 nm) and B (470 nm) (here, R, G, and B mean color models or color representing schemes defined as a red color, a green color, and a blue color, respectively). This corresponds to operation step (S06) shown in FIG. 4.

As shown in FIG. 5, the method of receiving a data signal in the underwater communication device 1000 using visible light is configured to include the following steps.

First, the visible light photosensitive unit 310 recognizes the visible light signal emitted from the visible light emitting unit 240 to the underwater under water. This corresponds to operation step (S07) shown in FIG. 5.

Next, since intensity of the visible light signal recognized in the visible light photosensitive unit 310 in step (SS07) may be weak, the amplifier 320 receives and amplifies the recognized visible light signal. This corresponds to operation step (S08) shown in FIG. 5.

Next, the demodulating unit 330 converts the visible light signal amplified in the amplifier 320 into the electrical signal. This corresponds to operation step (S09) shown in FIG. 5.

Next, since there may be an erroneously received signal in the visible light signal recognized in the visible light photosensitive unit 310 in step S07, the filter unit 340 performs filtering in order to remove the erroneously received portion. This corresponds to operation step (S10) shown in FIG. 5.

Finally, the output unit 400 converts the electrical signal filtered in the filter unit 340 into the audio or analog signal, which is the data signal, and outputs the converted signal under water. This corresponds to operation step (S11) shown in FIG. 5.

Therefore, according to the exemplary embodiment of the present invention, the communication is performed under water using the LED, which is an environment-friendly illumination, thereby making it possible to implement an environment-friendly and cheap underwater communication device.

However, the accompanying drawings are only examples shown in order to describe the technical idea of the present invention in more detail. Therefore, the technical idea of the present invention is not limited to shapes of the accompanying drawings.

The present invention is not limited to the above-mentioned exemplary embodiments, and may be variously applied, and may be variously modified without departing from the gist of the present invention claimed in the claims.

1. An underwater communication device using visible light, comprising:
an input unit 100 receiving a data signal under water and converting the data signal into an electrical signal;
a transmitting unit 200 including a signal magnitude adjusting unit 210 adjusting intensity of the electrical signal, a light emitting diode (LED) driving unit 220 driving an LED illumination or generating an illumination signal, a signal summing unit 230 summing up the electrical signal and the illumination signal to generate a complex light signal, and a visible light emitting unit 240 adjusting a wavelength of the complex light signal to emit a visible light signal to underwater, the LED driving unit 220 being operated in any one of an automatic mode of always driving the LED illumination and generating the illumination signal when it is confirmed that the signal magnitude adjusting unit 210 is driven, an illumination mode of always driving the LED illumination, a communication mode of always generating the illumination signal, and a turn off mode of not driving the LED illumination and not generating the illumination signal;
a receiving unit 300 recognizing the visible light signal under water and converting the visible light signal into the electrical signal; and
an output unit 400 converting the electrical signal into a data signal and outputting the data signal under water.

2. The underwater communication device using visible light of claim 1, wherein the data signal is an audio signal or an analog signal.

3. The underwater communication device using visible light of claim 1, wherein the input unit 100 is a microphone or a touch pad.

4. The underwater communication device using visible light of claim 1, wherein the output unit 400 is a headset or a monitor.

5. The underwater communication device using visible light of claim 1, wherein the LED driving unit 200 further includes a mode selecting switch 225 capable of selecting any one of the automatic mode, the illumination mode, the communication mode, and the turn off mode.

6. The underwater communication device using visible light of claim 1, wherein the receiving unit 300 includes:
a visible light photosensitive unit 310 recognizing the visible light signal;
an amplifier 320 amplifying the visible light signal;
a demodulating unit 330 converting the visible light signal into the electrical signal; and
a filter unit 340 filtering the electrical signal.

7. The underwater communication device using visible light of claim 6, wherein the visible light photosensitive unit 310 is a photodiode.

8. A method of transmitting a data signal under water in the underwater communication device 1000 using visible light of claim 1, comprising:
a step (S01) of setting the LED driving unit 220 to the automatic mode or the communication mode under water;
a step (S02) of inputting the data signal to the input unit 100 under water and converting the data signal into the electrical signal;
a step (S03) of adjusting, in the signal magnitude adjusting unit 210, a magnitude of the electrical signal;
a step (S04) of generating, in the LED driving unit 220, an illumination signal;
a step (S05) of summing up, in the signal summing unit 230, the electrical signal of which the magnitude is adjusted and the illumination signal to generate a complex light signal; and
a step (S06) of converting, in the visible light emitting unit 240, the complex light signal into the visible light signal and emitting the visible light signal to underwater.

9. A method of receiving a data signal under water in the underwater communication device 1000 using visible light of claim 6, comprising:
a step (S07) of recognizing, in the visible light photosensitive unit 310, the visible light signal emitted from the visible light emitting unit 240 under water;
a step (S08) of amplifying, in the amplifier 320, the visible light signal;
a step (S09) of converting, in the demodulating unit 330, the amplified visible light signal into the electrical signal;
a step (S10) of filtering, in the filter unit 340, the electrical signal; and
a step (S11) of converting, in the output unit 400, the filtered electrical signal into the data signal and outputting the data signal.
